(19) United States
(12) Patent Application Publication
(10) Pub. No.: US 2007/0078254 A1
(43) Pub. Date: Apr. 5, 2007

(54) Optical material and optical element

(75) Inventors: Mitsuaki Matsumoto, Hirakata (JP); Keiichi Kuramoto, Kadoma (JP); Nobuhiko Hayashi, Osaka (JP)

Correspondence Address: NDQ&M WATCHSTONE LLP, 1300 EYE STREET, NW, SUITE 1000 WEST TOWER, WASHINGTON, DC, 20005, US

(73) Assignee: Sanyo Electric Co., Ltd., Moriguchi (JP)

(21) Appl. No.: 11/526,701

(22) Filed: Sep. 26, 2006

(30) Foreign Application Priority Data
Sep. 30, 2005 (JP) JP2005-287560
Jul. 31, 2006 (JP) JP2006-208326

(51) Int. Cl. C08G 18/00; C08G 59/00

(52) U.S. Cl. 528/44; 528/87

(57) ABSTRACT

An optical resin material containing a hydrolysis/polycondensation product, having at least a hydroxyl group in a molecule, of metal alkoxide, a volatile low-molecular component and an organic polymer, wherein the volatile low-molecular component has a polar group (for example, a carboxylic acid group, a carbonyl group, and a hydroxyl group) which can bind to the hydroxyl group of the hydrolysis/polycondensation product of metal alkoxide.

### BACKGROUND OF THE INVENTION

1. Field of the Invention

The present invention relates to an optical resin material which can be used for optical parts or the like and an optical element using the optical resin material.

2. Description of the Related Art

Resin materials are in widespread use as a material for optical parts since they are lower in cost and have higher mass productivity than glass materials. However, in parts for a mobile phone or parts for optical communication, they are required to withstand a high temperature and high humidity storage test of 85° C. in temperature and 85% in humidity, and in materials for optical parts, it is needless to say that there is not a break or a deformation of the material and it is required that changes in optical properties such as an refractive index and the like are small. Most of common optical resins such as acrylate resins, epoxy resins, epoxy acrylate resins, urethane resins and the like are increasingly degraded under high temperature and high humidity environments of 85° C. and 85% and they gradually decrease in refractive index. Such a reduction in refractive index becomes an obstacle to the application of the optical resin material to parts for a mobile phone or parts for optical communication.

In order to suppress such a reduction in refractive index, a method of maintaining optical properties by enhancing a material itself has been previously proposed. For example, in Japanese Unexamined Patent Publication No. 11-322864, a method of improving reliability of an optical resin material by optimizing a sulfur content, polymer viscosity and the like in a thiol group-containing polymer is described. However, in such a method, since the restrictions on a material and a condition of preparation are large and therefore it is impossible to stabilize optical properties such as an refractive index, an Abbe constant and the like by optical design.

### SUMMARY OF THE INVENTION

It is an object of the present invention to provide an optical resin material which can reduce variations in a refractive index under high temperature and high humidity environments and an optical element using the optical resin material.

The present invention pertains to an optical resin material containing a hydrolysis/polycondensation product, having at least a hydroxyl group in a molecule, of metal alkoxide and a volatile low-molecular component, wherein the volatile low-molecular component has a group which can bind to the hydroxyl group of the hydrolysis/polycondensation product of metal alkoxide. Incidentally, metal alkoxide in the present specification refers to an organic metal compound having at least a group to become an OH group by hydrolysis.

The present inventors have noted that the refractive indices of the acrylate resins, epoxy resins and urethane resins, which have been conventionally used as an optical resin material, are deteriorated under high temperature and high humidity environments. The reason for the reduction in refractive index under high temperature and high humidity environments is assumed as follows.

Generally, a refractive index of a high polymer material is expressed by the equation (1):

$$\frac{{nD}^{ 2} - 1}{{nD}^{ 2} + 2} = \frac{[ R ]}{V} \qquad ( 1 )$$

wherein n_{D} represents a refractive index of a high polymer material, [R] represents the sum of atomic refraction, and V=M/ρ (M: monomer's molecular weight, ρ: polymer density) and the equation (1) is cited from “Refractive Index Control of Transparent High Polymers” Quarterly Review of Chemistry No. 39, 1998, edited by Chemical Society of Japan. It is found from the above equation (1) that a refractive index becomes large as a value of a right side increases.

It is found from the above equation (1) that the refractive index is deteriorated when number of bonds having small atomic refraction increases or a polymer density becomes low. Under high temperature and high humidity environments of 85° C. in temperature and 85% in humidity, the following changes develop.

(1) Since hydrolysis/polycondensation progresses due to high humidity and this brings resins into a high polymer, number of OH groups having large atomic refraction decreases.

(2) Cross-links between molecule chains are broken and a carbon single bond having large atomic refraction is changed to a carbon double bond having small atomic refraction

(3) A density is reduced by the volatilization of a component constituting a resin.

And, the following factor of reducing the refractive index is conceivable beside the above-mentioned changes in a state of a high polymer.

(4) Water with a low refractive index is introduced due to moisture absorption.

As described above, the refractive index of a conventional resin used as an optical resin material is deteriorated due to various factors under high temperature and high humidity environments.

The optical resin material of the present invention containing the above-mentioned hydrolysis/polycondensation product of metal alkoxide and the above-mentioned volatile low-molecular component has a characteristic that a refractive index increases under high temperature and high humidity environments. Therefore, by mixing the optical resin material of the present invention with a conventional optical resin such as an acrylate resin, the reduction in the refractive index of the conventional optical resin can be canceled by an increase in the refractive index of the optical resin material of the present invention and the variations in a refractive index under high temperature and high humidity environments can be suppressed.

Accordingly, an optical resin material of another aspect according to the present invention is characterized by containing the above-mentioned hydrolysis/polycondensation product of metal alkoxide and the above-mentioned volatile low-molecular component, and further containing an organic polymer.

In the optical resin material of the present invention, the refractive index increases by the volatilization of the volatile low-molecular component. The volatile low-molecular component in the present invention has a group which can bind to the hydroxyl group of the hydrolysis/polycondensation product of metal alkoxide. A hydrogen bond or a bond of polycondensation is formed between the hydroxyl group of the hydrolysis/polycondensation product of metal alkoxide and the group of the low-molecular component and the volatility of the low-molecular component is controlled, and therefore the refractive index can be stabilized over a long time.

Examples of the group of the low-molecular component include a carboxylic acid group, a carbonyl group, and a hydroxyl group, having a polarity.

Examples of the low-molecular component in the present invention include a monomer and an oligomer respectively produced from metal alkoxide, organic acid, alcohols and ketones. Preferably, the monomer and the oligomer respectively produced from metal alkoxide and the organic acid are used. And, as the low-molecular component, a compound containing a fluorine atom low in molecular refraction is preferably used. Therefore, a preferred low-molecular component includes metal alkoxide, organic acid, alcohol and ketone, which contain a fluorine atom.

As the metal alkoxide in the present invention, alkoxysilane is particularly preferably used. As the metal alkoxide, a substance having a methacryloxy group and/or an acryloxy group, or a styryl group is preferably employed. By using the metal alkoxide having such a double bond, it is possible to polymerize this double bond by irradiation of energy rays to cure the optical resin material.

Examples of the organic polymer used in the present invention include acrylate resins, epoxy resins, urethane resins, polyester acrylate resins, epoxy acrylate resins and mixtures thereof. Also, the above organic polymer includes an organic metal polymer material produced by hydrolyzing the above-mentioned metal alkoxide. And, the organic polymer in the present invention may be a polymer formed by dispersing particles of metal oxide such as SiO₂, TiO₂, ZrO₂ or Nb₂O₅ in these resins. And, the organic polymer in the present invention may have a double bond such as a methacryloxy group and an acryloxy group. By using the organic polymer having such a double bond, it is possible to polymerize this double bond by irradiation of energy rays to cure the optical resin material. And, when the hydrolysis/polycondensation product of metal alkoxide has a double bond, the organic polymer in the present invention can bind to these double bonds to form a cross linkage.

In the optical resin material containing the organic polymer of the present invention, it is preferred that variations in a refractive index under high temperature and high humidity environments of 85° C. in temperature and 85% in humidity is ±0.001 or less per 500 hours.

In the optical resin material of the present invention, a mixing rate of the hydrolysis/polycondensation product of metal alkoxide, the low-molecular component, and the organic polymer is appropriately adjusted for stable control of the refractive index and is not particularly limited, but it is preferred that the content of the hydrolysis/polycondensation product of metal alkoxide is 4 to 95% by weight, the content of the organic polymer is 4 to 95% by weight and the content of the low-molecular component is 1 to 30% by weight.

An optical element of the present invention is characterized by using the above-mentioned optical resin material of the present invention.

A compound optical element of the present invention is characterized by forming an optical resin layer consisting of the above-mentioned optical resin material of the present invention on the surface of a base material.

In a preferred embodiment according to the compound optical element of the present invention, it is characterized in that the base material is a lens and the optical resin layer is formed on the optical surface of the lens.

A material of the base material includes a substance consisting of glass, plastic, translucent ceramic, or optical crystal.

The above-mentioned glass includes a common optical glass and a highly refractive glass.

A material of the above-mentioned plastic includes acrylic resins such as polymethyl methacrylate, epoxy resins, silicone resins, fluororesins, polyolefin resins, polycarbonate, polyethylene terephthalate, polyethylene naphthalate, polymethylpentene, polystyrene, polyarylate, polysulfone, polyethersulfone, polyetherimide, polyimide, polyethylene, and polypropylene.

The above-mentioned translucent ceramic includes alumina, MgF₂, CaF₂, spinel sintered body, (PbLa) (ZrTi) O₃ (PLZT), yttrium aluminum garnet sintered body, and trade name “LUMICERA” produced by Murata Manufacturing Co., Ltd.

Examples of the optical crystal include quartz, rutile, spinel, sapphire, lithium niobate, lithium tantalate, potassium niobate, lead zirconate titanate, lead lanthanum zirconate titanate, potassium phosphate titanate, barium titanate, yttrium aluminum garnet, yttrium iron garnet, β-barium borate and lithium triborate; semiconductors such as silicon, germanium and the like; semiconductors and mixed crystals of Group II-Group VI compounds such as sulfur selenide, zinc selenide and the like; and semiconductors and mixed crystals of Group III-Group V compounds such as gallium arsenide, gallium phosphide, indium phosphide, aluminum arsenide, gallium nitride, aluminum nitride and the like.

An optical system of the present invention is characterized by comprising the above-mentioned compound optical element of the present invention.

Examples of the optical system of the present invention include optical communication devices such as a photonic switch, an optical transmitter and receiver module, an optical coupler and the like; display units such as a liquid crystal display, a plasma display, an organic electroluminescence display, a projector, a cineprojector and the like; optical parts such as a microlens array, an integrator, a light guiding plate and the like; cameras such as a digital camera and the like; image pickup apparatus such as a video camera and the like; image pickup modules such as a CCD camera module, a CMOS camera module and the like; and optical equipment such as a telescope, a microscope, a magnifying glass and the like.

By employing the optical resin material containing the organic polymer of the present invention, an optical resin material, which reduces variations in a refractive index under high temperature and high humidity environments and exhibits a stable refractive index, can be formed.

Since the optical resin of the present invention uses the above-mentioned optical material of the present invention, an optical element exhibiting a stable refractive index even under high temperature and high humidity environments can be formed from the optical resin of the present invention.

### BRIEF DESCRIPTION OF THE DRAWINGS

FIG. 1 is a schematic view showing a state in an optical resin material in an example according to the present invention;

FIG. 2 is a sectional view showing a compound aspheric lens prepared in an example according to the present invention;

FIG. 3 is a view showing a distribution of light intensity of a condensed light spot when light is condensed by a spherical lens;

FIG. 4 is a view showing a distribution of light intensity of a condensed light spot when light is condensed by a compound aspheric lens;

FIG. 5 is a sectional view showing a compound lens prepared in Example 7;

FIG. 6 is a schematic sectional view showing a camera module in an example according to the present invention;

FIGS. 7A and 7B are respectively views showing profiles (simulation) of condensed light spots before and after a high temperature and high humidity test of a compound lens in an example according to the present invention;

FIGS. 8A and 8B are respectively views showing profiles (simulation) of condensed light spots before and after a high temperature and high humidity test of a compound lens in a comparative example;

FIG. 9 is a diagram showing a configuration of a digital camera using a camera module in an example according to the present invention;

FIG. 10 is a diagram showing a schematic configuration of a projector using a compound lens according to the present invention; and

FIG. 11 is a schematic sectional view showing an optical transmitter and receiver module using a compound lens according to the present invention.

### DETAILED DESCRIPTION OF THE PREFERRED EMBODIMENTS

Hereinafter, the present invention will be described by way of examples, but the present invention is not limited to the following examples.

### COMPARATIVE EXAMPLE 1

A pre-curing viscous solution consisting of about 55% by weight of tolylene diisocyanate-containing polyurethane terminal methacrylate oligomer as a urethane acrylate resin, about 25% by weight of trimethylolpropane triacrylate, about 18% by weight of benzyl methacrylate and about 2% by weight of 1-hydroxycyclohexyl phenyl ketone as a photopolymerization initiator was used and this pre-curing viscous solution was irradiated for 4 minutes with light of a mercury lamp with illuminance of 500 mW/cm² to be cured. This cured substance was aged for 500 hours under high temperature and high humidity environments of 85° C. in temperature and 85% in humidity. A refractive index at an early stage of aging was 1.5350 and a refractive index after aging was 1.5338. Accordingly, the refractive index changed by −0.0012. Incidentally, the refractive index is also decreased in an acrylic resin “NOA 60” manufactured by Norland Co. by aging of the same conditions.

### COMPARATIVE EXAMPLE 2

6.0 ml of 3-methacryloxypropyltriethoxysilane (MPTES) as metal alkoxide was added to 15.0 ml of ethanol and to this mixture, 1.2 ml of 2N hydrochloric acid was added dropwise while stirring the mixture. The mixture was left standing for 2 days to allow a hydrolysis/polycondensation reaction to proceed. Next, to this mixture containing a hydrolysis/polycondensation reactant, 1.5 mg of 1-hydroxycyclohexyl phenyl ketone as a photopolymerization initiator was added, and then the resulting mixture was heated to 100° C. to eliminate ethanol to obtain a hydrolysis/polycondensation product of metal alkoxide.

This hydrolysis/polycondensation product was irradiated for 4 minutes with light of a mercury lamp with illuminance of 500 mW/cm² to be cured.

This cured substance was aged for 100 hours under high temperature and high humidity environments of 85° C. in temperature and 85% in humidity as with Comparative Example 1. A refractive index at an early stage of aging was 1.4845 and a refractive index after aging of 100 hours was 1.4868, and a change in the refractive index was found to be +0.0023.

The above-mentioned sample was analyzed by infrared absorption spectroscopy and consequently an increase of an OH group was found in a post-aging sample. It is thought that the reason for this is that an intrinsically stable Si—O—Si bond was hydrolyzed under high temperature and high humidity conditions and a Si—OH bond with large molecular refraction was produced. It is thought that the refractive index increased as a result of the increase of the OH group.

By mixing this hydrolysis/polycondensation product of metal alkoxide with a organic polymer such as an acrylate polymer, an epoxy polymer or a urethane polymer and curing this mixture, variations in a refractive index under high temperature and high humidity environments can be suppressed. However, in this method, the stability of a refractive index varies depending on a mixing ratio of the hydrolysis/polycondensation product of metal alkoxide. Since this mixing ratio also has an effect on other properties such as hardness, heat resistance and the like, this method alone is insufficient for stabilizing the refractive index.

In the present invention, by further adding the volatile low-molecular component, it is possible to maintain the refractive index stable without greatly changing a mixing ratio of the hydrolysis/polycondensation product of metal alkoxide and the organic polymer.

### COMPARATIVE EXAMPLE 3

Here, a volatile low-molecular component was mixed into an organic polymer to evaluate the effect of adding the volatile low-molecular component. Trifluoroacetic acid was used as the volatile low-molecular component and the same urethane acrylate resin as in Comparative Example 1 was used as the organic polymer. 20 mg of trifluoroacetic acid was added to 10 g of the urethane acrylate resin and then the resulting mixture was cured by irradiating ultraviolet rays as with the above case. The obtained cured substance was left standing under high temperature and high humidity environments and a change in the refractive index was measured as with the above case. The change in the refractive index after aging of 100 hours was −0.0001 and it could be very reduced, but the change in the refractive index after aging of 500 hours was −0.0010 and it was a refractive index equivalent to that of a sample to which the low-molecular component was not added

As is evident from the above-mentioned results, by just adding the volatile low-molecular component to the organic polymer, the low-molecular component is volatilized at a relatively early stage and the refractive index cannot be stabilized over a long time. In the present invention, by employing a low-molecular component having a group which can bind to the hydroxyl group of the hydrolysis/polycondensation product of metal alkoxide and forming a bond between the hydroxyl group of the hydrolysis/polycondensation product of metal alkoxide and the group of the low-molecular component, the volatilization rate of the volatile low-molecular component is controlled and the stability of the refractive index is secured over a long time.

And, it is preferred that some bond such as a bond formed by polymerization of an acrylic group, a hydrogen bond or a bond formed by overlapping of π electrons is also formed between the hydrolysis/polycondensation product of metal alkoxide and the organic polymer.

### EXAMPLE 1

In this example, MPTES was used as metal alkoxide, trifluoroacetic acid was used as a volatile low-molecular component and the same urethane acrylate resin as in Comparative Example 1 was used as an organic polymer. A method of preparing a sample is shown below.

(1) 6.0 ml of MPTES is added to 15.0 ml of ethanol and to this mixture, 1.2 ml of 2N hydrochloric acid is added dropwise while stirring the mixture. The mixture is left standing for 2 days to allow a hydrolysis/polycondensation reaction to proceed.

(2) The above-mentioned hydrolysis/polycondensation reactant is heated to 100° C. to eliminate ethanol. Thereby, a hydrolysis/polycondensation product of metal alkoxide is obtained.

(3) 1 g of the above-mentioned hydrolysis/polycondensation product of metal alkoxide and 20 mg of trifluoroacetic acid are added to 10 g of the same pre-curing viscous solution as in Comparative Example 1 and the resulting mixture is stirred.

(4) The obtained mixture is irradiated for 4 minutes with light of a mercury lamp with illuminance of 500 mW/cm² to be cured.

In MPTES, three ethoxy groups and a methacryloxy group bind to silicon as shown in the following chemical formula (1)

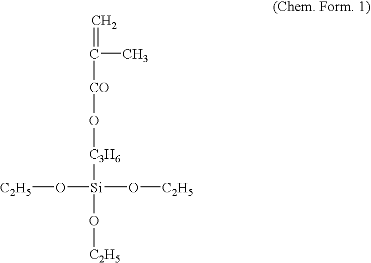

An ethoxy group reacts with water in hydrochloric acid to separate from MPTES by adding hydrochloric acid in the step of the above-mentioned chemical formula (1), and a molecule of the MPTES from which the ethoxy group is separated binds to another MPTES molecule from which an ethoxy group is also separated as shown in the chemical formula (2).

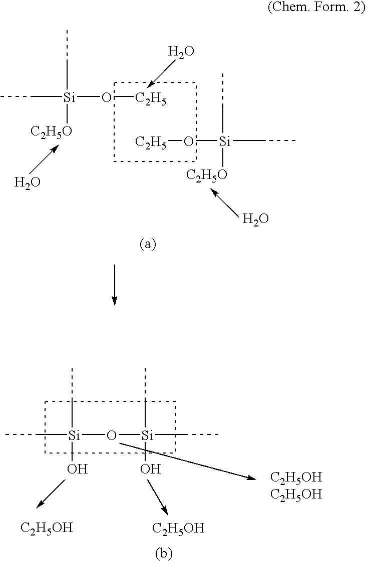

By continuing this reaction, a molecular chain of MPTES is formed, but a part of the ethoxy group is reacted with water to become an OH group as shown in the chemical formula (2).

Trifluoroacetic acid forms a hydrogen bond with this OH group as shown in the chemical formula (3).

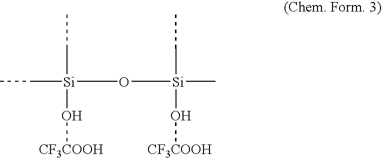

When ultraviolet rays are further irradiated to the molecular chain of MPTES, a double bond of a methacryloxy group bound to the molecular chain of MPTES breaks and a methacryloxy group in which the double bond is broken binds to a methacryloxy group, bound to another molecular chain, in which the double bond is similarly broken as shown in the chemical formula (4).

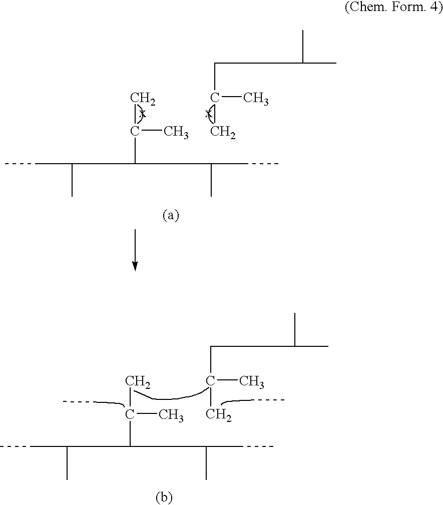

By thus bonding between the molecule chains, curing of a resin takes place. In addition, since a urethane acrylate resin also has a methacryloxy group or an acryloxy group, similar bonding arises also between these double bonds.

The sample which had been cured by irradiating ultraviolet rays in the above manner was aged for 500 hours under high temperature and high humidity environments of 85° C. in temperature and 85% in humidity, and a refractive index after aging was measured. The results of measurement are shown in Table 1. In addition, the results of Comparative Example 1 are also shown in Table 1.

As shown in Table 1, a refractive index at an early stage of aging was 1.5304 and a refractive index after aging of 500 hours was 1.5303, and a change in the refractive index was −0.0001. The change in the refractive index is considerably suppressed compared with −0.0012 which is the change in the refractive index in the case of using a urethane acrylate resin alone.

In addition, when 3-methacryloxypropyltrimethoxysilane (MPTMS) is employed as metal alkoxide in place of MPTES, a similar effect can be attained. And, even when metal alkoxide other than MPTES and MPTMS, i.e., other metal alkoxide having a methacryloxy group such as
3-methacryloxypropylmethyldimethoxysilane or
3-methacryloxypropylmethyldiethoxysilane, or
p-styryltrimethoxysilane having a styryl group is used, a similar effect can be attained. And,
3-acryloxypropyltrimethoxysilane having an acryloxy group in place of a methacryloxy group can also be used. Further, a part of these metal alkoxides having a methacryloxy group or an acryloxy group can be replaced with metal alkoxide not having a methacryloxy group, such as phenyltrimethoxysilane (PhTMS) and diphenyldimethoxysilane (DPhDMS).

And, even when trifluoroethanol or trifluoroacetone was mixed in place of trifluoroacetic acid as the volatile low-molecular component, a similar effect was attained. Also, organic fluorine compounds having polarity such as trifluorobenzoic acid, trifluoroacetophenone, difluoroacetic acid, difluorobenzoic acid and the like may be mixed.

And, as the organic polymer, organic metal polymer materials produced by hydrolyzing metal alkoxide, acrylate resins, epoxy resins, urethane resins, polyester acrylate resins, epoxy acrylate resins and mixtures thereof, and polymers formed by dispersing fine particles of metal oxide such as SiO₂, TiO₂, ZrO₂ or Nb₂O₅ in these resins may be used.

### EXAMPLE 2

In this example, MPTES was used as metal alkoxide, trifluoropropyltrimethoxysilane (TFPTMS), metal alkoxide, was used as a volatile low-molecular component and the same urethane acrylate resin as in Comparative Example 1 was used as an organic polymer. A method of preparing a sample is shown below.

(1) 6.0 ml of MPTES is added to 15.0 ml of ethanol and to this mixture, 1.2 ml of 2N hydrochloric acid is added dropwise while stirring the mixture. The mixture is left standing for 2 days to allow a hydrolysis/polycondensation reaction to proceed.

(2) Further, 2.0 ml of TFPTMS is added and the resulting mixture is stirred.

(3) The above mixture is heated to 100° C. to eliminate ethanol to obtain a hydrolysis/polycondensation product of metal alkoxide.

(4) The same pre-curing viscous solution as in Comparative Example 1 and the above-mentioned hydrolysis/polycondensation product of metal alkoxide are mixed in the proportions of 20:1 and the resulting mixture is stirred.

(5) The obtained mixture is irradiated for 4 minutes with light of a mercury lamp with illuminance of 500 mW/cm² to be cured.

In this example, a molecular chain of TFPTMS further binds to a molecular chain of MPTES as shown in the chemical formula (5). Since TFPTMS does not have a methacryloxy group and an acryloxy group, a bond of TFPTMS is apt to break compared with MPTES or a urethane acrylate resin.

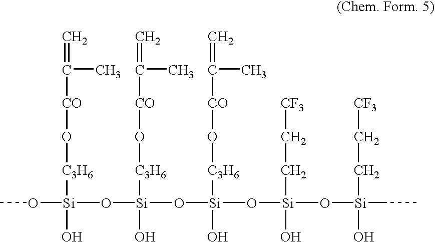

The above-mentioned sample was aged for 500 hours under high temperature and high humidity environments of 85° C. in temperature and 85% in humidity, and a refractive index after aging was measured. The results of measurement are shown in Table 1. As shown in Table 1, a refractive index at an early stage of aging was 1.5314 and a refractive index after aging was 1.5315, and a change in the refractive index was +0.0001. This change in the refractive index could be considerably suppressed compared with the case of using a urethane acrylate resin alone. Further, compounds as metal alkoxide and an organic polymer described in the above Example 1 can be also used in this example.

As for a photopolymerization initiator, an initiator alone contained in the organic polymer is sufficient for curing, but it is also possible to reduce a curing time by adding the photopolymerization initiator such as 1-hydroxycyclohexyl phenyl ketone to a hydrolysis/polycondensation product of metal alkoxide as required.

### EXAMPLE 3

In this example, MPTES and DPhDMS were used as metal alkoxide, trifluoroacetic acid was used as a volatile low-molecular component and the same urethane acrylate resin as in Comparative Example 1 was used as an organic polymer. This example is different from Example 1 in that a combination of a molecular chain of trifluoroacetic acid with that of metal alkoxide is accelerated by adding trifluoroacetic anhydride and heating a mixture. A method of preparing a sample is shown below.

(1) 4.0 ml of MPTES and 3.3 ml of DPhDMS are added to 15.0 ml of ethanol and to this mixture, 1.2 ml of 2N hydrochloric acid is added dropwise while stirring the mixture. The mixture is left standing for 2 days to allow a hydrolysis/polycondensation reaction to proceed and then the resulting mixture of a hydrolysis/polycondensation product is heated to 100° C. to eliminate ethanol.

(2) Next, to this, 1 ml of trifluoroacetic anhydride and 3.75 ml of trimethylethoxysilane are added, and the resulting mixture is stirred until they are not separated from each other.

(3) The mixture is left standing for 24 hours and then is heated to 100° C. to evaporate and eliminate trifluoroacetic anhydride and trimethylethoxysilane.

(4) The resulting mixture is dissolved in trimethylethoxysilane again and water is added to this solution and the mixture is stirred.

(5) The mixture is left standing for some time to be separated, and then a supernatant liquid is taken out and heated to eliminate trimethylethoxysilane.

(6) The same pre-curing viscous solution as in Comparative Example 1 and the above-mentioned product are mixed in the proportions of 3: 7 and the resulting mixture is stirred.

(7) The obtained mixture is irradiated for 4 minutes with light of a mercury lamp with illuminance of 500 mW/cm² to be cured.

As shown in the chemical formula (6), not only an ethoxy group of MPTES is separated from MPTES to form a molecular chain of MPTES but also a part of the ethoxy group is replaced with an OH group by partially reacting with water. In this example, this OH group is further replaced with trifluoroacetic acid by using a strong dehydration action of trifluoroacetic anhydride to treat the molecular chain in the steps (2) and (3) as shown in the chemical formula (6). This trifluoroacetic acid bound to the molecule chain becomes a low refractive index component in the present invention.

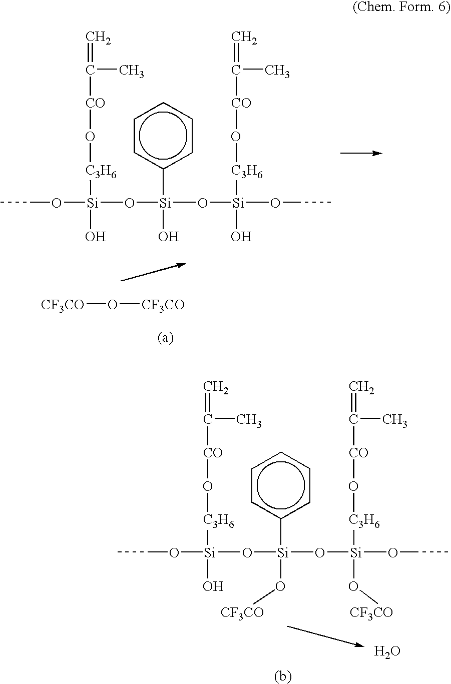

The above-mentioned sample was aged for 500 hours under high temperature and high humidity environments of 85° C. in temperature and 85% in humidity, and a refractive index after aging was measured. The results of measurement are shown in Table 1. As shown in Table 1, a refractive index at an early stage of aging was 1.5295 and a refractive index after aging of 500 hours was 1.5293, and a change in the refractive index was −0.0002. The change in the refractive index could be considerably suppressed compared with the change in the refractive index of a urethane acrylate resin.

In this example, since a reaction residual in a pre-curing resin is eluted into water in the steps (6) and (7), trifluoroacetic acid bound to the molecule chain of metal alkoxide through a hydrogen bond hardly remains as with Example 1. Therefore, it is thought that trifluoroacetic acid bound to the molecule chain is hydrolyzed to separate from the molecule chain in a reverse process of that shown in the chemical formula (6) under high temperature and high humidity environments and separated trifluoroacetic acid is volatilized, and thereby the refractive index was increased. Further, compounds as metal alkoxide and an organic polymer described in the above Example 1 can be also used in this example.

As for a photopolymerization initiator, an initiator alone contained in the organic polymer is sufficient for curing, but it is also possible to reduce a curing time by adding the photopolymerization initiator such as 1-hydroxycyclohexyl phenyl ketone to a hydrolysis/polycondensation product of metal alkoxide as required.

Next, a mixing ratio of the organic polymer is varied to obtain a cured substance and effects of the resulting cured substance on a refractive index were investigated. In the above-mentioned step (6), the same pre-curing viscous solution (organic polymer) as in Comparative Example 1 and the above-mentioned product were mixed in such a way that a mixing ratio of the organic polymer was 10% by weight, 20% by weight and 40% by weight as shown in Table 2, and this mixture was cured by irradiating light of a mercury lamp with illuminance of 30 mW/cm² to this mixture for 4 minutes to obtain a cured substance. The obtained cured substance was aged for 500 hours under high temperature and high humidity environments of 85° C. in temperature and 85% in humidity in the same manner as that described above, and refractive indices before and after aging were measured to determine a change in refractive index. The results of measurement are shown in Table 2.

And, the same pre-curing viscous solution (organic polymer) alone as in Comparative Example 1 was cured in the same manner as in the above case and the obtained cured substance was similarly evaluated on the refractive index. The results of measurement are shown in Table 2 as a case where a mixing ratio of organic polymer is 100%.

As is evident from the results shown in Table 2, it is understood that it is possible to reduce the changes in the refractive index and stabilize the refractive index by setting the mixing ratio of the organic polymer within the range of 20 to 40% by weight.

In the above-mentioned step (6), the same pre-curing viscous solution as in Comparative Example 1 and the above-mentioned product are mixed in the proportions of 3: 7 and the mixing ratio of the organic polymer is set at 30% by weight which is within the above-mentioned range.

### EXAMPLE 4

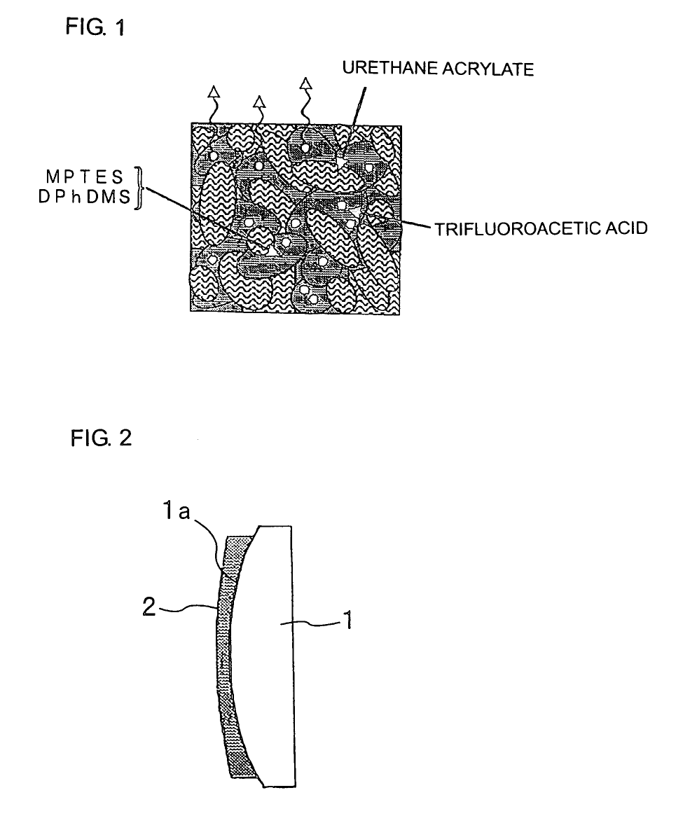

In this example, trifluoroacetic anhydride was added to a resin synthesized from MPTES and DPhDMS and the same urethane acrylate resin as in Comparative Example 1 was further mixed in this mixture and the resulting mixture was cured. The structure of the cured substance is as shown in the chemical formula (7) and FIG. 1.

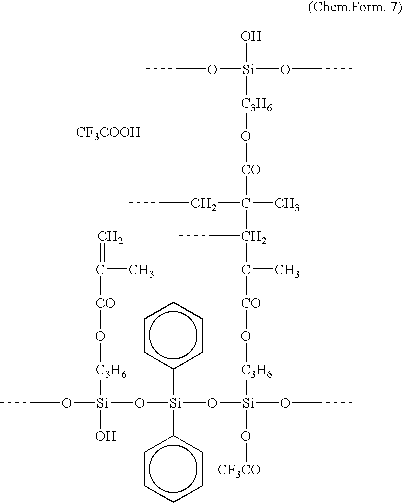

A method of preparing a sample is shown below.

(1) 15.3 ml of MPTES and 6.34 ml of DPhDMS are added to 40 ml of ethanol and to this mixture, 3.8 ml of 2N hydrochloric acid is added dropwise while stirring the mixture.

(2) Next, to this, 1 ml of trifluoroacetic anhydride and 3.75 ml of trimethylethoxysilane are added, and the resulting mixture is stirred until they are not separated from each other.

(3) The mixture is left standing for 24 hours and then is heated to 100° C. to evaporate and eliminate trifluoroacetic anhydride and trimethylethoxysilane.

(4) The same pre-curing viscous solution as in Comparative Example 1 and the above-mentioned product are mixed in the proportions of 4: 6.

(5) A composition thus obtained is irradiated for 4 minutes with light of a mercury lamp with illuminance of 500 mW/cm² to be cured.

In this example, since a step of removing a reaction residual by water is omitted, most of trifluoroacetic acid produced by hydrolysis of trifluoroacetic anhydride binds to a molecular chain of metal alkoxide through a hydrogen bond and other part of trifluoroacetic acid exists in the form of a covalent bond in a resin.

The above-mentioned sample was aged for 500 hours under high temperature and high humidity environments of 85° C. in temperature and 85% in humidity, and a refractive index after aging was measured. The results of measurement are shown in Table 1. As shown in Table 1, a refractive index at an early stage of aging was 1.5308 and a refractive index after aging was 1.5312, and a change in the refractive index was +0.0004. Therefore, the change in the refractive index could be considerably suppressed compared with the case of using a urethane acrylate resin alone. Further, compounds as metal alkoxide and an organic polymer described in the above Example 1 can be also used in this example.

As for a photopolymerization initiator, an initiator alone contained in the organic polymer is sufficient for curing, but it is also possible to reduce a curing time by adding the photopolymerization initiator such as 1-hydroxycyclohexyl phenyl ketone to a hydrolysis/polycondensation product of metal alkoxide as required.

TABLE 1

| | Refractive Index | | |
|---|---|---|---|
| | | | Change in |
| | Early Stage of Aging | After Aging | Refractive Index |
| Comp. Ex. 1 | 1.5350 | 1.5338 | −0.0012 |
| Ex. 1 | 1.5304 | 1.5303 | −0.0001 |
| Ex. 2 | 1.5314 | 1.5315 | +0.0001 |
| Ex. 3 | 1.5295 | 1.5293 | −0.0002 |
| Ex. 4 | 1.5308 | 1.5312 | +0.0004 |

TABLE 2

| | Refractive Index | | |
|---|---|---|---|
| Mixing Ratio of | Early | | Change in |
| Organic Polymer | Stage of Aging | After Aging | Refractive Index |
| 10% | 1.534 | 1.5348 | 0.0008 |
| 20% | 1.5345 | 1.5348 | 0.0003 |
| 40% | 1.5345 | 1.5343 | −0.0002 |
| 100% | 1.5313 | 1.5302 | −0.0011 |

### EXAMPLE 5

FIG. 2 is a sectional view showing a lens of this example. As shown in FIG. 2, in this example, an optical resin layer 2 having an aspheric surface is provided on the spherical surface 1a of a base material spherical lens 1. The base material spherical lens 1 is made of BK7 glass and has a spherical surface 1a having a radius of curvature of 5 mm, a diameter of 5 mm and a focal length of 9 mm. By providing the optical resin layer 2 having an aspheric surface on this spherical surface 1a, a compound aspheric lens is prepared.

A shape of the aspheric surface can be generally expressed by the following equation.

$$\frac{( {x}^{2} + {y}^{2} ) / R}{1 + \sqrt{1 + ( K + 1 ) \times ( {x}^{2} + {y}^{2} ) / {R}^{2}}} + Higher Order Term$$

$$\begin{matrix}R \text{:} Radius of Curvature \\ K \text{:} Conic Constant\end{matrix}$$

In the above equation, K is a constant referred to as a conic constant and a principal parameter to decide the shape of the aspheric surface. And, R represents a radius of curvature. In this example, the aspheric surface is designed for the purpose of correcting a spherical aberration and its radius of curvature R is the same 5 mm as the base material spherical lens and its conic constant K is −0.55. And, the above higher order term was omitted. A thickness of the optical resin layer 2 was set at 0.1 mm at the lens center. Further, as a material of the optical resin layer 2, the resin of the above Example 3 was used.

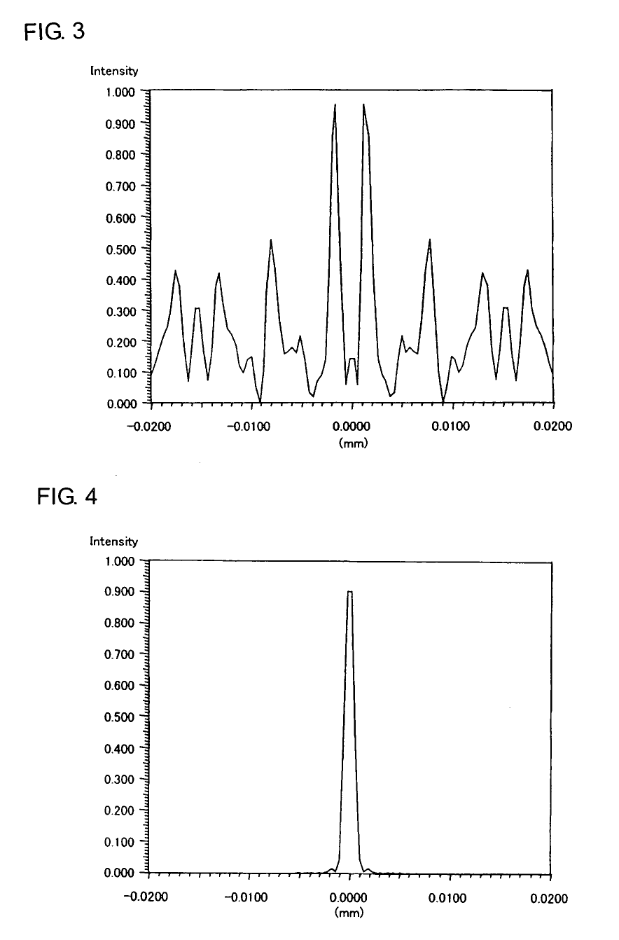

FIG. 3 shows the result obtained by condensing beams of a helium-neon laser with a wavelength of 633 nm using a base material spherical lens 1 before forming an aspheric optical resin layer and measuring a distribution of light intensity of the resulting condensed light spot with a beam profiler. As shown in FIG. 3, when the spherical lens 1 was used, laser beams could not be condensed into a spot due to a spherical aberration.

FIG. 4 shows the result obtained by measuring a distribution of light intensity of a condensed light spot with a beam profiler in the same manner as in the above description using a compound aspheric lens in which the aspheric optical resin layer 2 is formed on the spherical lens 1 as shown in FIG. 2. As shown in FIG. 4, by using the compound aspheric lens of this example, laser beams could be condensed into a minute spot.

The optical element of the present invention is not limited to applications in the above examples and it can also be applied to, for example, a diffractive optics in which a diffraction grating is formed on the surface of a plate glass or a lens, and a lens, a prism, or a diffractive optics composed of an optical resin alone. And, as a material of a plate glass or a lens, common optical glasses such as BK glass other than BK7 glass of this example, F glass and SF glass, optical glasses such as S-TIH series, S-LAH series, S-LAL series and S-YGH series, manufactured by OHARA INC., or plastic or highly refractive translucent ceramic can be used.

And, the optical material of the present invention can be used in resin materials for various coatings such as an anti-reflection coating; resin materials for molding optical parts such as an LED, a photosensor, a photocoupler, a photointerrupter and a photoreflector; resin materials for optical parts such as a lens, an optical fiber, an optical waveguide and a filter used for optical communication devices such as a photonic switch, an optical transmitter and receiver module and an optical coupler; resin materials for optical parts such as a lens, a microlens array, an integrator and a light guiding plate used for display units such as a liquid crystal display, a plasma display, an organic electroluminescence display, a projector and a cineprojector; resin materials for optical parts such as a plastic lens and a compound aspheric lens used for cameras including a digital camera etc., image pickup apparatus such as a video camera and image pickup modules such as a CCD camera module and a CMOS camera module; and resin materials for optical parts such as a plastic lens and a compound aspheric lens used for other optical equipment such as a telescope, a microscope, a contact lens, eyeglasses and a magnifying glass.

### EXAMPLE 6

In this example, a material of the base material lens in Example 5 was changed from BK7 glass to an optical plastic. As a plastic material, a cyclic olefin resin (trade name “ZEONEX” produced by ZEON Corporation) was used. A lens shape of the base material and an aspheric shape of an optical resin layer are similar to those of Example 5 and also a used material of the optical resin layer was the resin of Example 3 as with Example 5. A focal length was 8.7 mm different from that of Example 5 since a refractive index of the base material is different from that of Example 5.

Also in this example, such a beam profile as shown in FIGS. 3 and 4 could be attained and a laser beam could be condensed into a minute spot as with Example 5.

The same results as in the above description were also attained in forming the optical resin layer using a cyclic olefin resin (trade name “ARTON” produced by JSR Corporation, trade name “APEL” produced by Mitsui Chemicals, Inc., and trade name “TOPAS” produced by Polyplastics Co., Ltd.) and a fluorene polyester resin (trade name “OKP4” produced by Osaka Gas Chemicals Co., Ltd.) in place of the above-mentioned resin.

### EXAMPLE 7

In this example, an aspheric optical resin layer was formed on a base material spherical glass lens as with Example 5. This optical resin layer not only corrects a spherical aberration but also constitutes an achromat lens system by a compound lens and reduces a chromatic aberration.

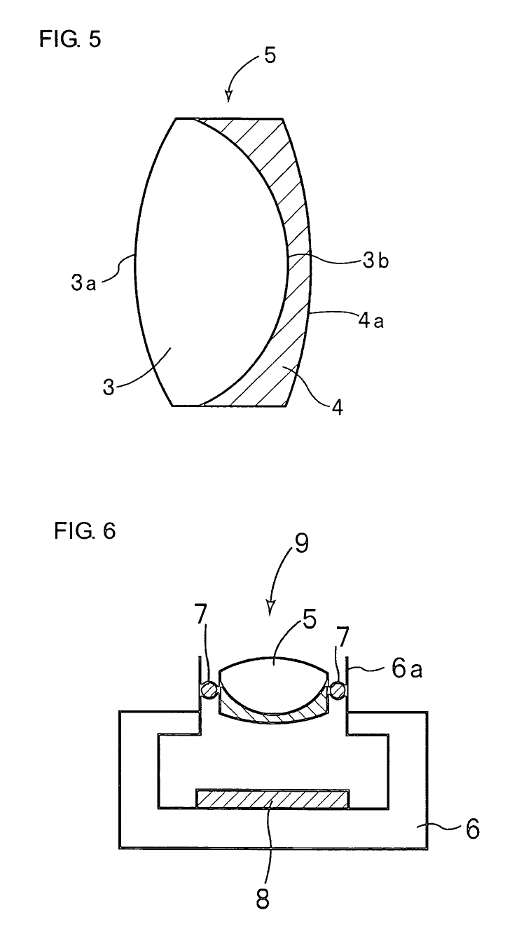

FIG. 5 is a sectional view showing a compound lens 5 in the achromat lens system of this example. A glass lens base material 3 has convex spherical surfaces on both side, and a lens diameter is 3 mm and a radius of curvature of a first surface 3a is 3 mm and a radius of curvature of a second surface 3b is 1.6 mm. The optical resin layer 4 is formed on the second surface 3b using the resin material of Example 3. A radius of curvature and a conic constant of an aspheric surface 4a of the optical resin layer 4 are 5.6 mm and 5.95, respectively. A thickness of the optical resin layer 4 is 0.05 mm at the lens center.

Further, a compound lens in which the optical resin layer 4 was formed using the resin material of Comparative Example 1 was prepared as a comparative example. This compound lens has about the same shape and dimension as the above-mentioned compound lens of this sample, but its conic constant is 5.45 because the refractive index of the optical resin layer 4 is different.

In order to evaluate light-condensing performance of the compound lenses of this example and comparative example thus prepared, a camera module shown in FIG. 6 was prepared. An image pickup device (CCD) 8 was attached to a bottom in a metal frame 6 and the compound lens 5 was secured to an opening portion 6a in the top of the frame 6 by a fixture 7 to prepare the camera module.

Using the camera module of this example and comparative example thus prepared, light of a white point light source located in the distance was imaged and a lens position was adjusted in such a way that a spot size is minimized while observing an output image of a CCD and fixed.

Next, these camera modules were placed in a testing apparatus of 85° C. in temperature and 85% in humidity and left standing for 500 hours, and then light of a white point light source located in the distance was imaged again and an output image of a CCD was observed.

In the camera module using the compound lens of this example, light was well condensed as with the camera module before placing it in the testing apparatus, but in the camera module using the compound lens of the comparative example, light-condensing was inadequate and light was out of focus.

In order to clarify differences in the above-mentioned high temperature and high humidity test between the compound lens of this example and the compound lens of the comparative example, profiles of a condensed light spot before and after the test were determined by a simulation. Specifically, this simulation was carried out from surface configurations and refractive indices of the base material lens and the optical resin layer of the compound lens according to a ray tracing method.

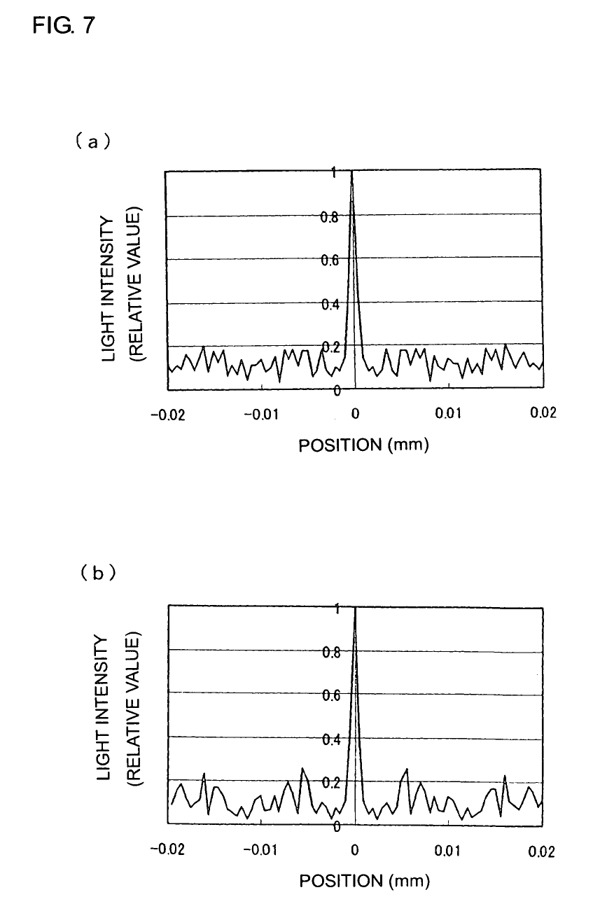

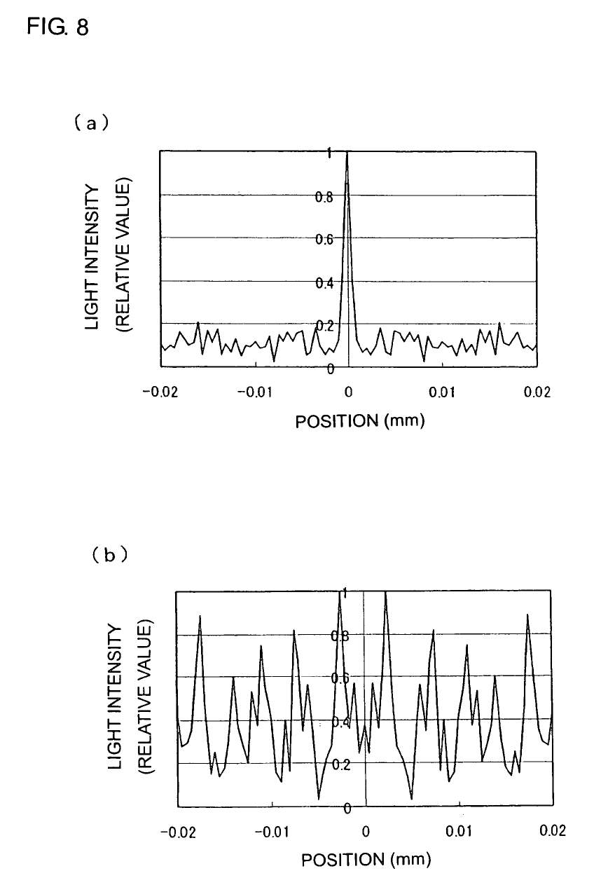

FIGS. 7A and 7B show profiles of the condensed light spot of this example, and G 7A is a profile before the high temperature and high humidity test and G 7B is a profile after the high temperature and high humidity test. And, FIGS. 8A and 8B show profiles of the comparative example, and FIG. 8A is a profile before the high temperature and high humidity test and FIG. 8B is a profile after the high temperature and high humidity test.

As is apparent from the results shown in FIGS. 7 and 8, in the compound lens of this example, the deterioration of light-condensing performance under high temperature and high humidity environments is suppressed compared with the compound lens of comparative example.

### EXAMPLE 8

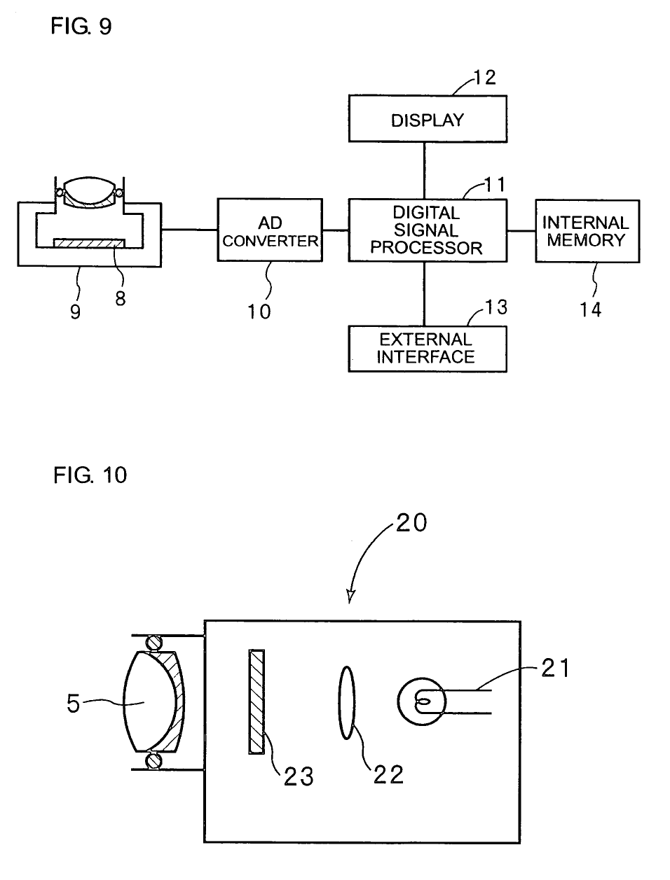

FIG. 9 is a diagram showing a configuration of a digital camera using a camera module in the above Example 7. Analogue signals from an image pickup device 8 of the camera module 9 are converted to digital signals by an AD converter 10 and sent to a digital signal processor 11. Digital signals from the digital signal processor 11 are provided for a display 12 and image display is performed. Also, digital signals are sent to an internal memory 14 and stored therein. And, an external interface 13 for external connection is connected to the digital signal processor 11.

### EXAMPLE 9

FIG. 10 is a diagram showing a schematic configuration of a projector using a compound optical element of the present invention. A lighting lamp 21 is installed in the projector 20, and in the direction of light output of the lighting lamp 21, a lighting lens 22 and a liquid crystal display (LCD) 23 are provided, and a compound lens 5 is installed forward of the liquid crystal display 23.

The compound lens 5 used in this example uses S-FPL51 manufactured by OHARA INC as a glass lens base material, and in this lens, a lens diameter is 50 mm, a radius of curvature of a first surface is 60 mm and a radius of curvature of a second surface is 32 mm. An optical resin layer of the compound lens 5 is formed on the second surface using the resin material of Example 3 and a radius of curvature and a conic constant of the optical resin layer are 112 mm and −2.5, respectively. A thickness of the optical resin layer is 2 mm at the lens center.

The projector of this example can suppress the deterioration of lens characteristics under high temperature and high humidity environments since it employs the compound lens of the present invention.

### EXAMPLE 10

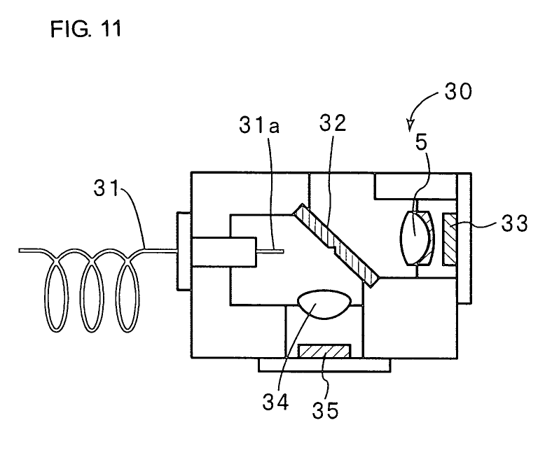

FIG. 11 is a schematic sectional view showing an optical transmitter and receiver module using the compound optical element of the present invention.

One end 31a of an optical fiber 31 is inserted into the optical transmitter and receiver module 30 and a light-emitting device 33 is provided at a position opposed to the one end 31a of an optical fiber 31. A compound lens 5 according to the present invention is installed forward of the light-emitting device 33 and a wavelength selection filter 32 is placed in a state of being inclined at 45° between the compound lens 5 and the end 31a of the optical fiber 31. A light-receiving device 35 is located through a lens 34 below the wavelength selection filter 32.

Light exiting the light-emitting device 33 passes through the compound lens 5 and the wavelength selection filter 32 and enters the optical fiber 31 via the end 31a and is transmitted through the fiber.

And, light sent from the optical fiber 31 passes through the end 31a and is reflected by the wavelength selection filter 32, and reflected light passes through the lens 34 and is received at the light-receiving device 35.

In this example, as the light-emitting device 33, a semiconductor laser having an oscillation wavelength of 1.3 μm was employed. The compound lens 5 according to the present invention is used so that output light from the light-emitting device 33 may enter the optical fiber 31 with efficiency. As a glass lens base material of the compound lens 5, BK7 glass was used. A lens diameter of the glass lens base material is 2 mm, radii of curvature of a first surface, a second surface and an aspheric surface of an optical resin layer are 1.2 mm, respectively. A conic constant of the aspheric surface of the optical resin layer is −3.5. A thickness of the optical resin layer is 0.1 mm at the lens center.

Further, an optical transmitter and receiver module configured just like the optical transmitter and receiver module of this example was configured except for using a compound lens for comparison, in which the optical resin layer was formed using the resin of Comparative Example 1, as a comparative example was prepared.

At the time immediately after preparing the module, in both optical transmitter and receiver modules of this example and the comparative example, the output light of the semiconductor laser has the coupling efficiency of about 60% to an optical fiber. These optical transmitter and receiver modules were placed in a testing apparatus of 85° C. in temperature and 85% in humidity and left standing for 500 hours, and then the coupling efficiency of the output light of the semiconductor laser was measured in the same manner as in the above description. In this example, the coupling efficiency was about 60% and it hardly changed after placing the module in a testing apparatus, but in the optical transmitter and receiver module of the comparative example, the coupling efficiency was reduced to about 45%. From this result, it is evident that by using a compound lens according to the present invention, an optical transmitter and receiver module which exhibits a stable light-transmitting and receiving characteristic even under high temperature and high humidity conditions is obtained.

What is claimed is:

1. An optical resin material containing a hydrolysis/polycondensation product, having at least a hydroxyl group in a molecule, of metal alkoxide and a volatile low-molecular component, wherein said volatile low-molecular component has a group which can bind to the hydroxyl group of said hydrolysis/polycondensation product of metal alkoxide.

2. The optical resin material according to claim 1, further comprising an organic polymer.

3. The optical resin material according to claim 1, wherein said group of the low-molecular component is a carboxylic acid group, a carbonyl group, or a hydroxyl group.

4. The optical resin material according to claim 1, wherein a bond between said hydroxyl group of the hydrolysis/polycondensation product of metal alkoxide and said group of the low-molecular component is formed by a hydrogen bond or polycondensation.

5. The optical resin material according to claim 1, wherein said low-molecular component is metal alkoxide, organic acid, alcohol or ketone, which contains a fluorine atom.

6. The optical resin material according to claim 2, wherein said organic polymer is at least a resin selected from acrylate resins, epoxy resins, epoxy acrylate resins, and urethane resins.

7. The optical resin material according to claim 1, wherein said hydrolysis/polycondensation product of metal alkoxide has a double bond and the double bond is polymerized by irradiation of energy rays to cure the optical resin material.

8. The optical resin material according to claim 2, wherein said organic polymer has a double bond and the double bond is polymerized by irradiation of energy rays to cure the optical resin material.

9. The optical resin material according to claim 1, wherein said hydrolysis/polycondensation product of metal alkoxide has a double bond and is in a state of being not yet cured before irradiation of energy rays.

10. The optical resin material according to claim 2, wherein said organic polymer has a double bond and is in a state of being not yet cured before irradiation of energy rays.

11. The optical resin material according to claim 1, wherein variations in a refractive index under high temperature and high humidity environments of 85° C. in temperature and 85% in humidity is ±0.001 or less per 500 hours.

12. An optical element using the optical resin material according to claim 1.

13. A compound optical element, wherein an optical resin layer consisting of the optical resin material according to claim 1 is formed on the surface of a base material.

14. The compound optical element according to claim 13, wherein said base material is a lens and said optical resin layer is formed on the optical surface of said lens.

15. The compound optical element according to claim 13, wherein said base material consists of glass, plastic, translucent ceramic, or optical crystal.

16. An optical system comprising the compound optical element according to claim 13.
